(19) United States
(12) Patent Application Publication
(10) Pub. No.: US 2021/0241626 A1
(43) Pub. Date: Aug. 5, 2021

(54) VEHICLE DISPATCH DEVICE, VEHICLE DISPATCH METHOD, COMPUTER PROGRAM, AND COMPUTER-READABLE RECORDING MEDIUM

(71) Applicant: SUMITOMO ELECTRIC INDUSTRIES, LTD., Osaka-shi, Osaka (JP)

(72) Inventors: Shigeki NISHIMURA, Osaka-shi, Osaka (JP); Shoichi TANADA, Osaka-shi, Osaka (JP)

(73) Assignee: SUMITOMO ELECTRIC INDUSTRIES, LTD., Osaka-shi, Osaka (JP)

(21) Appl. No.: 17/049,591

(22) PCT Filed: Dec. 21, 2018
(86) PCT No.: PCT/JP2018/047275

§ 371 Date: Oct. 22, 2020

(30) Foreign Application Priority Data
May 23, 2018 (JP) 2018-098942

(51) Int. Cl. G08G 1/00; G01C 21/34; B60L 58/13; G06Q 10/02; G06Q 50/30

(52) U.S. Cl. CPC G08G 1/202; G01C 21/3469; B60L 2240/62; G06Q 10/02; G06Q 50/30; B60L 58/13

(57) ABSTRACT

A program according to an aspect of the present invention is a computer program for causing a computer to function as a device for dispatching a vehicle to a user, the computer program causing the computer to function as: an acquisition unit configured to acquire a vehicle dispatch request; and an information processing unit configured to select candidate vehicles that are candidates to be dispatched to the user, in accordance with the acquired vehicle dispatch request, wherein, when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

### TECHNICAL FIELD

The present invention relates to a vehicle dispatch device, a vehicle dispatch method, a computer program, and a computer-readable storage medium.

This application claims priority on Japanese Patent Application No. 2018-098942 filed on May 23, 2018, the entire contents of which are incorporated herein by reference.

### BACKGROUND ART

PATENT LITERATURE 1 describes a system in which a center device capable of performing wireless communication with a vehicle dispatches a vehicle for moving from a riding position designated by a user to a destination, in response to a vehicle dispatch request received from a user terminal.

In the above vehicle dispatch system, when the center device receives a vehicle dispatch request from a user terminal, the center device determines a vehicle that can arrive at the riding position of the user earliest, as a dispatch vehicle, and transfers the vehicle dispatch request received from the user terminal, to an on-vehicle device of the determined dispatch vehicle.

### CITATION LIST

### Patent Literature

PATENT LITERATURE 1: Japanese Laid-Open Patent Publication No. 2016-091411

### SUMMARY OF INVENTION

(1) A computer program according to an aspect of the present invention is a computer program for causing a computer to function as a device for dispatching a vehicle to a user, the computer program causing the computer to function as: an acquisition unit configured to acquire a vehicle dispatch request; and an information processing unit configured to select candidate vehicles that are candidates to be dispatched to the user, in accordance with the acquired vehicle dispatch request, wherein, when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

(8) A method according to an aspect of the present invention is a method for dispatching a vehicle to a user, the method including: a first step of acquiring a vehicle dispatch request; and a second step of selecting candidate vehicles that are candidates to be dispatched to the user, in accordance with the acquired vehicle dispatch request, wherein the second step includes a step of, when the selected candidate vehicles include an electric vehicle, determining the electric vehicle to be dispatched, on the basis of a charging priority of an area including a riding position of the user or a current position of the electric vehicle, a charging priority of an area including a destination of the user, and a remaining battery charge of the electric vehicle.

(9) A device according to an aspect of the present invention is a device for dispatching a vehicle to a user, the device including: an acquisition unit configured to acquire a vehicle dispatch request; and an information processing unit configured to select candidate vehicles that are candidates to be dispatched to the user, in accordance with the acquired vehicle dispatch request, wherein, when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

(10) A storage medium according to an aspect of the present invention is a non-transitory computer-readable storage medium having stored therein a computer program for causing a computer to function as a device for dispatching a vehicle to a user, the computer program causing the computer to function as: an acquisition unit configured to acquire a vehicle dispatch request; and an information processing unit configured to select candidate vehicles that are candidates to be dispatched to the user, in accordance with the acquired vehicle dispatch request, wherein, when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

The present invention can be realized not only as a system and a device having the characteristic configurations as described above, but also as a program for causing a computer to execute such characteristic configurations.

In addition, the present invention can be realized as a semiconductor integrated circuit that realizes a part or all of the system and the device.

### BRIEF DESCRIPTION OF DRAWINGS

FIG. 1 is a diagram showing an overall configuration of a vehicle dispatch system according to an embodiment of the present invention.

FIG. 2 is a block diagram of a vehicle dispatch server and an on-vehicle device included in the vehicle dispatch system.

FIG. 3 is an explanatory diagram showing variation of a charging priority map.

FIG. 4 is a sequence diagram showing an example of information processing executed by each component of the vehicle dispatch system.

FIG. 5 is a flowchart showing an example of a candidate vehicle selection process.

FIG. 6 illustrates a determination table which summarizes the contents of an electric vehicle upgrading process.

### DESCRIPTION OF EMBODIMENTS

### Problem to be Solved by the Present Disclosure

For example, if the penetration rate of electric vehicles increases, the driver of each electric vehicle preferably avoids charging the electric vehicle in an area having a low charging priority, where the power supply and demand situation is tight, and charges the electric vehicle in an area having a high charging priority, where there is a margin in the power supply and demand situation.

However, the conventional vehicle dispatch system does not assume what electric vehicle should be dispatched in consideration of the power supply and demand situation of an area including a riding position of a user and the power supply and demand situation of an area including a destination of the user.

In view of the conventional problem, an object of the present disclosure is to allow an appropriate electric vehicle to be dispatched in accordance with a charging priority of an area including a riding position of a user or the current position of the electric vehicle and a charging priority of an area including a destination of the user.

### Effect of the Present Disclosure

According to the present disclosure, an appropriate electric vehicle can be dispatched in accordance with the charging priority of the area including the riding position of the user or the current position of the electric vehicle and the charging priority of the area including the destination of the user.

### Outline of Embodiment of the Present Disclosure

Hereinafter, the outline of an embodiment of the present disclosure is listed and described.

(1) A program according to the present embodiment is a computer program for causing a computer to function as a device for dispatching a vehicle to a user, the computer program causing the computer to function as: an acquisition unit configured to acquire a vehicle dispatch request; and an information processing unit configured to select candidate vehicles that are candidates to be dispatched to the user, in accordance with the acquired vehicle dispatch request, wherein, when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

According to the computer program of the present embodiment, since the information processing unit determines the electric vehicle to be dispatched, on the basis of the charging priority of the area including the riding position of the user or the current position of the electric vehicle, the charging priority of the area including the destination of the user, and the remaining battery charge of the electric vehicle, an appropriate electric vehicle can be dispatched in accordance with the charging priority of the area including the riding position of the user and the current position of the electric vehicle and the charging priority of the area including the destination of the user.

(2) Specifically, when the charging priority of the area including the riding position of the user or the current position of the electric vehicle is low and the charging priority of the area including the destination of the user is high, the information processing unit prioritizes dispatching the electric vehicle having a remaining battery charge that is equal to or larger than an amount of power required for travelling to the destination and is as small as possible.

Accordingly, a possibility that charging will be performed in the area including the destination and having a high charging priority, rather than in the area including the riding position or the current position and having a low charging priority, is increased.

(3) When the charging priority of the area including the destination of the user is low, the information processing unit prioritizes dispatching the electric vehicle having a remaining battery charge that is equal to or larger than an amount of power required for travelling to the destination and is as large as possible.

Accordingly, a possibility that charging will be performed in the area including the destination and having a low charging priority, is decreased.

(4) In the program of the present embodiment, the information processing unit preferably determines the charging priority of each of the areas on the basis of a power supply and demand situation of the area.

In this case, a possibility that charging will be performed in the area including the destination and having a margin in the power supply and demand situation, rather than in the area including the riding position and having no margin in the power supply and demand situation, can be increased, or a possibility that charging will be performed in the area including the destination and having no margin in the power supply and demand situation, can be decreased.

(5) In the program of the present embodiment, the information processing unit preferably determines the charging priority of each of the areas on the basis of a charging station installation density of the area.

In this case, a possibility that charging will be performed in the area including the destination and having a high installation density, rather than in the area including the riding position and having a low installation density, can be increased, or a possibility that charging will be performed in the area including the destination and having a low installation density, can be decreased.

(6) In the program of the present embodiment, the information processing unit preferably determines the charging priority of each of the areas on the basis of a renewable energy utilization rate of the area.

In this case, a possibility that charging will be performed in the area including the destination and having a high utilization rate, rather than in the area including the riding position and having a low utilization rate, can be increased, or a possibility that charging will be performed in the area including the destination and having a low utilization rate, can be decreased.

(7) In the program of the present embodiment, when the vehicle dispatch request includes the riding position and the destination of the user, the acquisition unit preferably acquires the vehicle dispatch request including the riding position and the destination of the user.

In this case, a communication unit capable of performing wireless or wired communication with the user terminal also serves as an acquisition source of the riding position, the destination, and the vehicle dispatch request of the user.

(8) A vehicle dispatch method according to the present embodiment is a vehicle dispatch method achieved when a computer executes the computer program according to the above (1) to (7).

Therefore, the vehicle dispatch method of the present embodiment exhibits the same operation and effect as those of the computer program according to the above (1) to (7).

(9) A device according to the present embodiment is a vehicle dispatch device composed of a computer that executes the computer program according to the above (1) to (7).

Therefore, the vehicle dispatch device of the present embodiment exhibits the same operation and effect as those of the computer program according to the above (1) to (7).

(10) A storage medium according to the present embodiment is a non-transitory computer-readable storage medium having stored therein the computer program according to the above (1) to (7).

Therefore, the storage medium of the present embodiment exhibits the same operation and effect as those of the computer program according to the above (1) to (7).

### Details of Embodiment of the Present Disclosure

Hereinafter, embodiments of the present disclosure will be described with reference to the drawings. At least some parts of the embodiments described below may be combined together as desired.

### Definition of Terms

Prior to describing the details of the present embodiment, first, terms used in this specification will be defined.

“Vehicle”: A vehicle that travels on a road and in which two or more persons including a driver can ride. Not only automobiles, light automobiles, and trolleybuses, but also motorcycles can be vehicles.

The power source of the vehicle is not particularly limited. Therefore, examples of the vehicle include ICEVs (internal combustion engine vehicles), EVs (electric vehicles), PHVs (plug-in hybrid vehicles), PHEVs (plug-in hybrid electric vehicles), etc.

“Probe information”: Various kinds of information, regarding a vehicle traveling on a road, sensed by the vehicle.

The probe information is also referred to as probe data or floating car data. The probe information includes various kinds of vehicle data such as vehicle identification information, vehicle position, vehicle speed, vehicle direction, and the generation times thereof.

### Overall Configuration of System

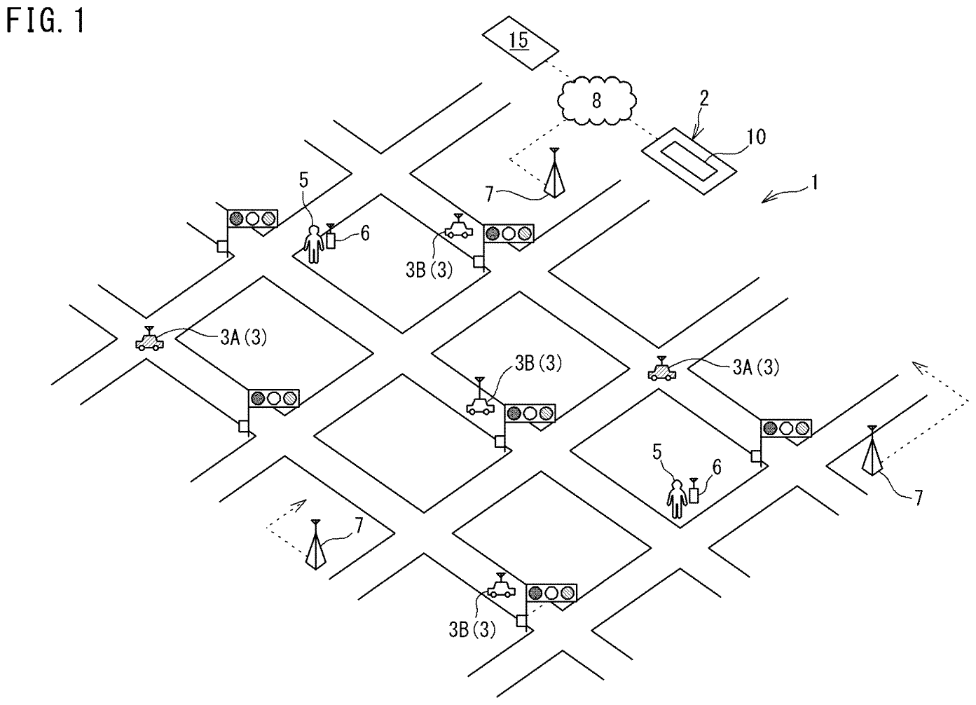

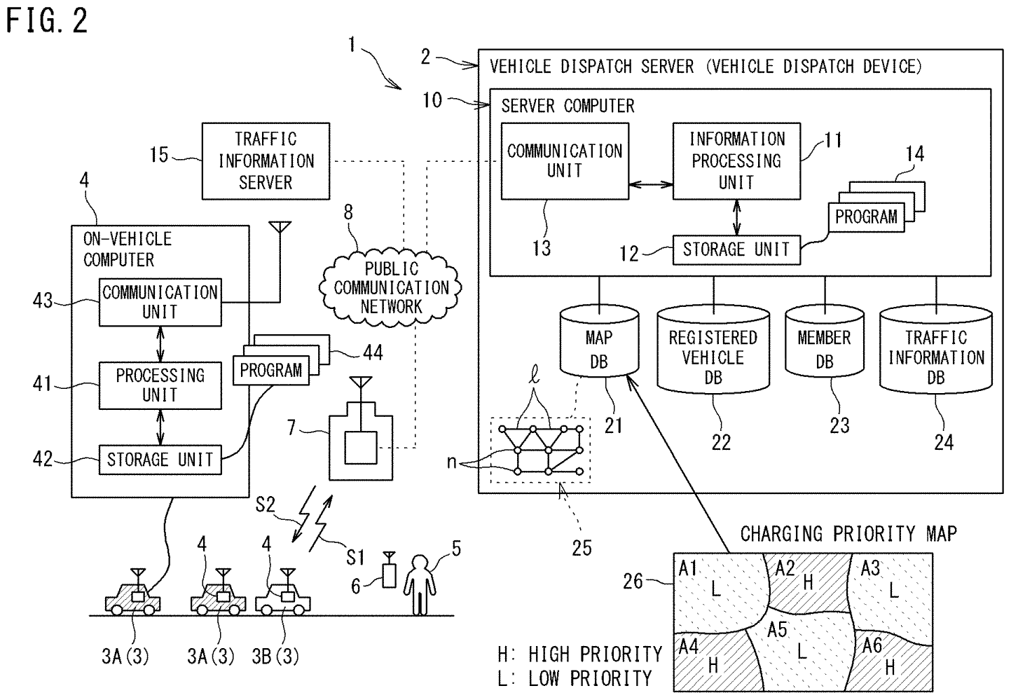

FIG. 1 is a diagram showing an overall configuration of a vehicle dispatch system 1 according to an embodiment of the present invention. FIG. 2 is a block diagram of a vehicle dispatch server 2 and an on-vehicle device 4 included in the vehicle dispatch system 1.

As shown in FIG. 1 and FIG. 2, the vehicle dispatch system 1 according to the present embodiment includes the vehicle dispatch device 2 that is a kind of information processing device installed in a data center, on-vehicle devices 4 of vehicles 3, and user terminals 6 possessed by users 5.

The vehicle dispatch device 2 of the present embodiment is composed of a computer device having a server function operated by a taxi company or an IT company that operates a vehicle dispatch business. The vehicle dispatch device 2 does not necessarily need to be a server, but is assumed to be a server in the present embodiment.

The vehicle dispatch server 2 has a vehicle dispatch function for matching a user 5 who is registered as a member in the vehicle dispatch server 2 in advance, with a vehicle 3 that is registered in the vehicle dispatch server 2 in advance and can provide a pick-up service.

The vehicle dispatch function is realized by a process of determining a vehicle 3 suitable for the user 5 to move from a riding position to a destination, in accordance with a request received from the user terminal 6, a process of transmitting the riding position of the user 5 to the determined vehicle 3, a process of transmitting information about the determined vehicle 3 to the user terminal 6, etc.

The on-vehicle device 4 of each vehicle 3 is capable of performing wireless communication with wireless base stations 7 (for example, mobile base stations) in various places. Each wireless base station 7 is capable of performing wireless communication with the vehicle dispatch server 2 via a public communication network 8 such as the internet.

Therefore, each on-vehicle device 4 can wirelessly transmit uplink information Si addressed to the vehicle dispatch server 2, to the wireless base stations 7. The vehicle dispatch server 2 can transmit downlink information S2 addressed to a specific on-vehicle device 4, to the public communication network 8.

The user terminal 6 of each user 5 is composed of a data communication terminal that can be carried by the user 5, such as a smartphone, a tablet computer, or a notebook computer. The user terminal 6 is capable of performing wireless communication with the wireless base stations 7 in the various places.

Therefore, each user terminal 6 can wirelessly transmit uplink information S1 addressed to the vehicle dispatch server 2, to the wireless base stations 7. The vehicle dispatch server 2 can transmit downlink information S2 addressed to a specific user terminal 6, to the public communication network 8.

The vehicles 3 include electric vehicles (hereinafter, also referred to as “EVs”) 3A whose power sources are only electric motors, and normal vehicles 3B that are vehicles 3 other than the electric vehicles 3A.

Therefore, the normal vehicles 3B include internal combustion engine vehicles (ICEVs) whose power sources are internal combustion engines. Each normal vehicle 3B may be a hybrid vehicle (for example, PHV or PHEV) that uses both an electric motor and an internal combustion engine. Hereinafter, the electric vehicles 3A and the normal vehicles 3B are collectively referred to as “vehicles 3”.

### Configuration of Vehicle Dispatch Server

As shown in FIG. 2, the vehicle dispatch server 2 includes a server computer 10 composed of a workstation, and various databases 21 to 24 connected to the server computer 10. The server computer 10 includes an information processing unit 11, a storage unit 12, and a communication unit 13.

The storage unit 12 is a storage device including at least one nonvolatile memory (storage medium) of an HDD (hard disk drive) and an SSD (solid state drive), and a volatile memory (storage medium) including a random access memory and the like.

The information processing unit 11 is composed of an arithmetic processing device including a CPU (Central Processing Unit) that reads out computer programs 14 stored in the nonvolatile memory of the storage unit 12 and performs information processing according to the programs 14.

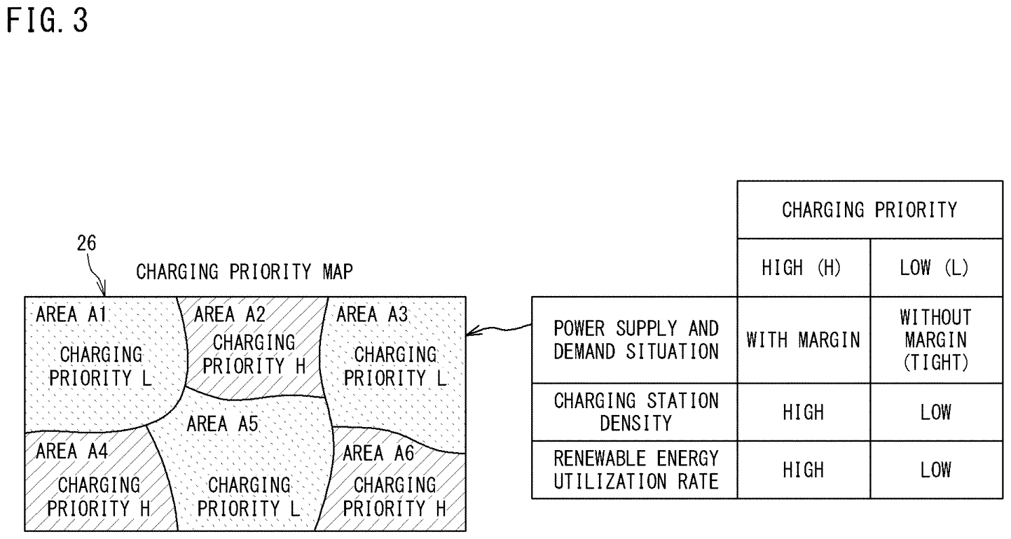

The computer programs 14 include a communication control program for the communication unit 13 as well as programs for causing the information processing unit 11 to execute processes required to determine a vehicle 3 to be dispatched to a user 5, such as a later-described “candidate vehicle selection process” (step ST13 in FIG. 3), etc.

The communication unit 13 is communicably connected to another information providing server such as a traffic information server 15 via the public communication network 8.

The traffic information server 15 is a server computer operated by a predetermined information service provider. The traffic information server 15 transmits domestic VICS information acquired from the VICS (“VICS” is a registered trademark of the Vehicle Information and Communication System Center) center to partners every predetermined time (for example, five minutes).

The communication unit 13 is a communication interface that communicates with the wireless base stations 7 via the public communication network 8. The communication unit 13 is capable of receiving uplink information 51 transmitted by the wireless base station 7 to the own device, and is capable of transmitting downlink information S2 generated by the own device to the wireless base station 7.

When the received uplink information 51 is a vehicle dispatch request including a riding position and a destination of a user 5, the communication unit 13 transfers the vehicle dispatch request to the information processing unit 11.

Therefore, the information processing unit 11 also has a function as an acquisition unit to acquire a vehicle dispatch request including a riding position and a destination of a user 5. The information processing unit 11 may acquire a riding position and a destination, and a vehicle dispatch request from different acquisition sources. For example, the information processing unit 11 may acquire the riding position and the destination from the member database 23, and acquire the vehicle dispatch request from the communication unit 13.

Each of the databases 21 to 24 is composed of a large-capacity storage including an HDD, an SSD, or the like, which is connected to the server computer 10 such that data can be transferred therebetween.

Road map data 25 covering the whole country is recorded in the map database 21. The road map data 25 includes “intersection data” and “link data”.

The “intersection data” is data in which an intersection ID assigned to a domestic intersection and position information of the intersection are associated with each other. The “link data” consists of data in which the following information 1) to 4) is associated with a link ID of a specific link assigned to a domestic road.

Information 1): Position information of start/end/interpolation points of a specific link

Information 2): Link ID that connects to the start point of the specific link

Information 3): Link ID that connects to the end point of the specific link

Information 4): Link cost of the specific link

The road map data 25 constitutes a network corresponding to actual road alignment and traveling directions on roads. Therefore, the road map data 25 is a network in which road sections between nodes representing intersections are connected by directed links l (lowercase letter l).

Specifically, the road map data 25 is composed of a directed graph in which a node n is set for each intersection and each node n is connected by a pair of directed links l in opposite directions. Therefore, in the case of a one-way road, nodes n are connected only by directional links l in one direction.

The road map data 25 also includes road type information in which a specific directed link l corresponding to each road on the map represents whether the road is a general road or a toll road, facility information representing the type of a facility such as a parking area or a tollgate included in a directed link l, etc.

A charging priority map 26 is recorded in the map database 21. The charging priority map 26 is a map in which a charging priority is defined for each of predetermined areas A1 to A6.

The “charging priority” is an index representing the degree of recommendation of charging an electric vehicle 3A in each of the areas A1 to A6. Therefore, the areas A1, A3, and A5 having a low charging priority mean areas in which charging is not recommended. On the other hand, the areas A2, A4, and A6 having a high charging priority mean areas in which charging is recommended.

The vehicle database 22 includes “static information” of each of the vehicles 3 registered in the vehicle dispatch server 2 in advance, and “dynamic information” of each of the registered vehicles 3.

The static information of each vehicle 3 includes identification information of the vehicle 3 (for example, vehicle identification number), the model of the vehicle 3, the power type of the vehicle 3, the name of the vehicle 3, the passenger capacity, the name of the driver of the vehicle 3, image data of the appearance of the vehicle 3, etc.

The power types of the vehicles 3 include ICEV, EV, PHV, PHEV, etc.

Each electric vehicle 3A in the present embodiment means a vehicle 3 having a power type of “EV”, and each normal vehicle 3B in the present embodiment means a vehicle 3 having a power type other than EV, that is, “ICEV”, “PHV”, or “PHEV”.

In the case of a vehicle 3 (electric vehicle 3A) having a power type of EV, the electric mileage of the vehicle 3 is also included in the static information.

The electric mileage is the travelable distance per kWh calculated from the remaining battery charge and the past traveling history of the electric vehicle 3A. Therefore, when the current remaining battery charge is denoted by Br (kWh) and the electric mileage is denoted by EM (km/kWh), a travelable distance Lr of the electric vehicle 3A at the current time can be calculated by the calculation equation Lr=Br×EM.

The value of the electric mileage may be calculated by the distribution server 2 for each electric vehicle 3A from the past probe information of the electric vehicle 3A accumulated in the vehicle database 22 and the remaining battery charge of the electric vehicle 3A.

The value of the electric mileage may be a value that is individually calculated by each electric vehicle 3A from the past traveling history and the remaining battery charge of the electric vehicle 3A and declared to the vehicle dispatch server 2.

The dynamic information of each vehicle 3 includes probe information of the vehicle 3, a service state of the vehicle 3, etc. When the vehicle 3 is an electric vehicle 3A, a remaining battery charge is also included in the probe information.

The service state of each vehicle 3 is information representing whether the vehicle 3 is in service. For example, if the service state is “occupied”, it means that a customer is already in the vehicle 3 and the vehicle 3 is traveling, and indicates that a new user 5 cannot ride in the vehicle 3. If the service state is “empty”, it means that no customer is in the vehicle 3, and indicates that a new user 5 can ride in the vehicle 3.

The member database 23 includes personal information such as the address and name of each registered member (user 5) and identification information of the user terminal 6 of each registered member (for example, at least one of a MAC address, an email address, a telephone number, etc.).

In the traffic information database 24, traffic information (for example, link travel time) received from the traffic information server 15 every predetermined time (for example, five minutes) is accumulated for each directed link l. The traffic information in the traffic information database 24 is updated every predetermined time.

### Configuration of On-Vehicle Device

As shown in FIG. 2, each on-vehicle device 4 is composed of a computer device including a processing unit 41, a storage unit 42, a communication unit 43, etc.

The processing unit 41 is composed of an arithmetic processing device including a CPU and an ECU (electric control unit) that read out computer programs 44 stored in a nonvolatile memory of the storage unit 42 and perform various kinds of information processing according to the programs 44.

The storage unit 42 is a storage device including at least one nonvolatile memory (storage medium) of an HDD and an SSD and a volatile memory (storage medium) including a random access memory and the like.

The computer programs 44 include a communication control program for the communication unit 43 as well as an operation control program to be executed by the ECU of the processing unit 41, an image processing program for displaying a travelling route on the display of a navigation device, etc.

The communication unit 43 is composed of a wireless communication device constantly installed in the vehicle 3, or a data communication terminal temporarily installed in the vehicle 3 (for example, a smartphone, a tablet computer, or a notebook computer).

The communication unit 43 has a GPS (global positioning system) receiver. The processing unit 41 monitors the vehicle position of the own vehicle in almost real time on the basis of GPS position information received by the communication unit 43.

The processing unit 41 collects vehicle data such as the vehicle position, the vehicle speed, and CAN information of the own vehicle every predetermined sensing cycle (for example, 0.1 s), and stores the data together with the generation times thereof in the storage unit 12. When the own vehicle is an electric vehicle 3A, the processing unit 41 also includes the remaining battery charge (kWh) at the current time in the vehicle data to be stored in the storage unit 42.

When vehicle data is accumulated for a predetermined time (for example, one second) in the storage unit 42, the communication unit 33 transmits the accumulated vehicle data as probe information to the vehicle dispatch server 2.

The on-vehicle device 4 of each vehicle 3 includes an input interface (not shown) that receives input of an operation of the driver. The input interface is composed of, for example, an input device attached to the navigation device, an input device of a data communication terminal mounted on the vehicle 3, or the like.

The storage unit 42 stores therein the type of the latest service state (occupied or empty) inputted into the input interface by an occupant. The communication unit 43 transmits the type of the current service state stored in the storage unit 42 to the vehicle dispatch server 2 every predetermined time (for example, one second).

### Variation of Charging Priority Map

FIG. 3 is an explanatory diagram showing variation of the charging priority map 26.

As shown in FIG. 3, the charging priority of each of the areas A1 to A6 of the charging priority map 26 can be defined so as to be associated with an index such as a “power supply and demand situation”, a “charging station installation density”, or a “renewable energy utilization rate”.

The power supply and demand situation refers to a value (%) obtained by dividing the demanded power in a predetermined power supply area (for example, an area to which one substation supplies power) by the power supplied to the area.

The charging station installation density (hereinafter, sometimes abbreviated as “installation density”) refers to the number of charging stations installed per unit area (for example, 2 square km). The renewable energy utilization rate refers to the ratio (%) of renewable energy to the total amount of power generated in a predetermined power supply area (for example, an area to which one substation supplies power).

In the case where the charging priority of each of the areas A1 to A6 is defined by the “power supply and demand situation”, an area having a margin in the power supply and demand situation (for example, an area where demanded power/supplied power is less than 90%) may be defined as an area whose charging priority is “high”.

The reason for this is that, in the case of an area having a margin in the power supply and demand situation, there is nothing to hinder charging an electric vehicle 3A in this area.

On the other hand, an area having no margin in the power supply and demand situation, that is, an area where the power supply and demand situation is tight (for example, an area where demanded power/supplied power is 90% or greater) may be defined as an area whose charging priority is “low”.

The reason for this is that, in the case of an area having no margin in the power supply and demand situation, charging an electric vehicle 3A in this area causes further deterioration of the power supply and demand situation.

In the case where the charging priority is defined by the “power supply and demand situation”, the unit of each of the areas A1 to A6 may be, for example, an area to which one substation supplies power.

The power supply and demand situation of each of the areas A1 to A6 changes with the season and time. Thus, preferably, the power supply and demand situation of each of the areas A1 to A6 is collected from a server computer or the like of an electric power company every predetermined time (for example, one hour), and the charging priority map 26 is sequentially updated.

In the case where the charging priority of each of the areas A1 to A6 is defined by the “charging station installation density”, an area having a high installation density (for example, an area having an installation density of “3” or higher) may be defined as an area whose charging priority is “high”.

The reason for this is that an area having a high charging station installation density is an area where a charging station is easily encountered, and thus is an area where it is easy for the driver of an electric vehicle 3A to charge the electric vehicle 3A.

On the other hand, an area having a charging station low installation density (for example, an area having an installation density less than “3”) may be defined as an area whose charging priority is “low”.

The reason for this is that an area having a low charging station installation density is an area where it is difficult to encounter a charging station, and thus is an area where it is difficult for the driver of an electric vehicle 3A to charge the electric vehicle 3A.

In the case where the charging priority is defined by the charging station installation density, the unit of each of the areas A1 to A6 may be, for example, a mesh obtained by dividing the land by a square having a predetermined distance (for example, 2 km) on one side.

The installation density of each of the areas A1 to A6 may vary depending on a charging station construction situation, etc. Thus, the operator of the vehicle dispatch server 2 preferably investigates the installation density of each of the areas A1 to A6 every predetermined period (for example, one month) and sequentially updates the charging priority map 26.

In the case where the charging priority of each of the areas A1 to A6 is defined by the “renewable energy utilization rate”, an area having a high utilization rate (for example, an area having a utilization rate of 15% or higher) may be defined as an area whose charging priority is “high”.

The reason for this is that charging in an area having a high renewable energy utilization rate leads to a large degree of promotion of utilization of renewable energy, and its contribution to environmental measures such as CO₂ reduction is large.

On the other hand, an area having a low utilization rate (for example, an area having a utilization rate less than 15%) may be defined as an area whose charging priority is “low”.

The reason for this is that charging in an area having a low renewable energy utilization rate leads to a small degree of promotion of utilization of renewable energy, and its contribution to environmental measures such as CO₂ reduction is not so large.

In the case where the charging priority is defined by the renewable energy utilization rate, the unit of each of the areas A1 to A6 may be, for example, an area to which one substation supplies power.

The utilization rate of each of the areas A1 to A6 may vary depending on a development situation in each place such as the penetration rate of photovoltaic power generation. Therefore, the operator of the vehicle dispatch server 2 preferably investigates the utilization rate of each of the areas A1 to A6 every predetermined period (for example, one month) and sequentially updates the charging priority map 26.

### Information Processing in Vehicle Dispatch System

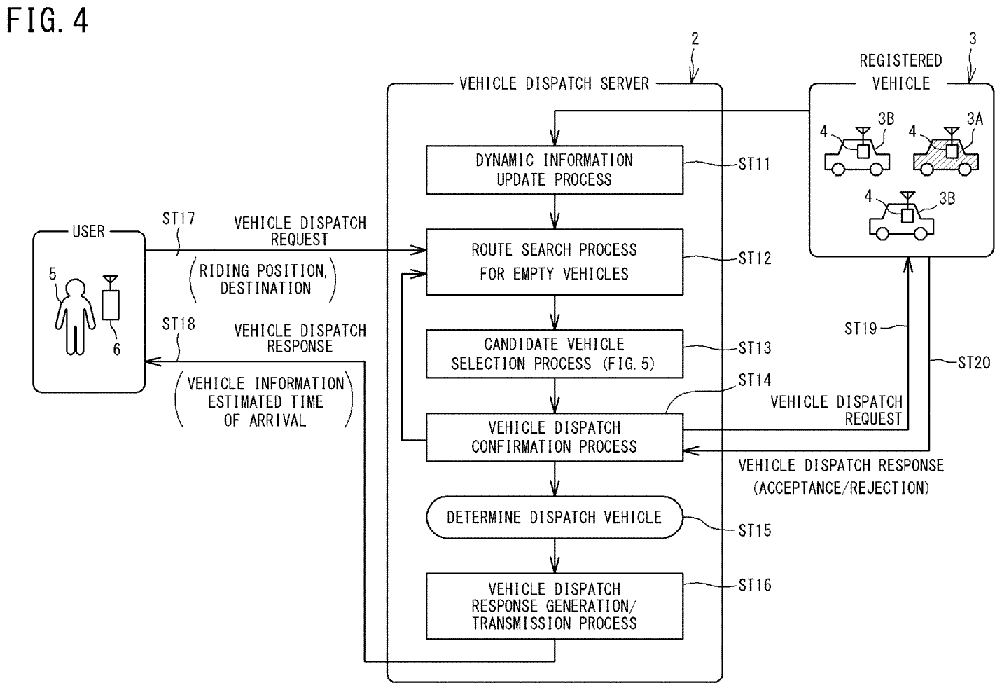

FIG. 4 is a sequence diagram showing an example of information processing executed by each of the components 2, 4, and 6 of the vehicle dispatch system 1.

In the following description, the execution subjects of the respective processes are the vehicle dispatch server 2, the on-vehicle device 4, and the user terminal 6, but the actual execution subjects are the information processing unit 11 of the vehicle dispatch server 2, the processing unit 41 of the on-vehicle device 4, and a processing unit (not shown) of the user terminal 6.

As shown in FIG. 4, the vehicle dispatch server 2 executes a “dynamic information update process” regardless of the presence/absence of reception of a vehicle dispatch request from the user terminal 6 (step ST11).

The dynamic information update process is a process of, each time the dynamic information (probe information and service state) of each vehicle 3 is received, updating the dynamic information of the vehicle 3. That is, upon receiving dynamic information from each vehicle 3, the vehicle dispatch server 2 replaces the dynamic information included in the vehicle database 22 and corresponding to the identification information of the vehicle 3, with the most recently received new dynamic information.

When the user 5 inputs a riding position and a destination into the user terminal 6, the user terminal 6 transmits a vehicle dispatch request to the vehicle dispatch server 2 (step ST17).

The vehicle dispatch request includes position information (for example, latitudes and longitudes) of the riding position and the destination of the user 5. The position information of the riding position and the destination are automatically generated by the processing unit of the user terminal 6 from the address or the like where the user 5 performs the input into the user terminal 6.

Input of a riding position into the user terminal 6 is optional. That is, when the user 5 has not inputted a riding position into the user terminal 6, it may be considered that the user 5 desires to ride in a vehicle at the current position, and the current position of the user terminal 6 may be set as a riding position of the user 5.

Position information of the current position of the user terminal 6 is automatically generated by the GPS receiver included in the user terminal 6.

The vehicle dispatch server 2 that has received the vehicle dispatch request executes a “route search process for empty vehicles” (step ST12).

The route search process for empty vehicles is a process of, for each of vehicles 3 whose service states are “empty” and that are present within a predetermined range from the riding position of the user 5, searching for an optimal route from the current position of the vehicle 3 via the riding position of the user 5 to the destination of the user 5.

The above predetermined range may be a range centered on the riding position of the user 5 and having a radius that is within a predetermined distance (for example, 4 km). The size of the predetermined range may be dynamically changed in accordance with whether the service area including the riding position of the user 5 is a city center or a suburb, the density of the vehicles 3 present in the service area, and the like.

The route search process is performed based on a predetermined route search logic such as the Dijkstra method or the potential method.

Specifically, the vehicle dispatch server 2 sets the link closest to the departure point of the vehicle 3 as a start link, sets the links closest to a waypoint and the destination as a via link and an end link, extracts a route having a smallest total link cost obtained by a predetermined calculation equation, by the route search logic, from among the routes passing through the start link/via link/end link, and sets the extracted route as an optimum route for the vehicle 3.

Next, the vehicle dispatch server 2 executes the “candidate vehicle selection process” (step ST13).

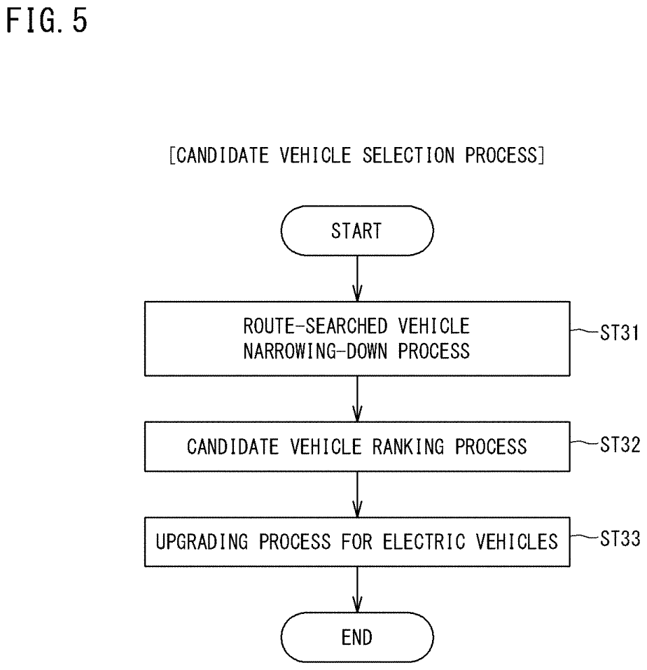

The candidate vehicle selection process is a process of selecting one or more vehicle 3 candidates (hereinafter, referred to as “candidate vehicle”) to be dispatched to the user 5, from among the empty vehicles 3 for which route search has been performed. The candidate vehicle selection process also includes a process of, in the case of a plurality of candidate vehicles, ranking the candidate vehicles. The candidate vehicle selection process (FIG. 5) will be described in detail later.

Next, the vehicle dispatch server 2 executes a “vehicle dispatch confirmation process” for the selected candidate vehicles (step ST14).

The vehicle dispatch confirmation process is a process of confirming, for each of the one or more candidate vehicles determined in the candidate vehicle selection process (step ST13), whether the driver accepts the vehicle dispatch request of the user 5. The vehicle dispatch confirmation process is performed by transmitting and receiving the vehicle dispatch request and a vehicle dispatch response between the vehicle dispatch server 2 and each vehicle 3 that is a candidate.

Specifically, the vehicle dispatch server 2 transmits the vehicle dispatch request to the on-vehicle device 4 of the candidate vehicle having the highest transmission rank (candidate vehicle whose transmission rank is the first place) (step ST19).

The vehicle dispatch request to be transmitted to the on-vehicle device 4 includes the position information of the riding position and the destination of the user 5. Information such as the name and the telephone number of the user 5 may be included in the vehicle dispatch request such that the driver of the vehicle 3 can authenticate the user 5 immediately before the user 5 gets in the vehicle 3.

The on-vehicle device 4 that has received the vehicle dispatch request displays the fact that the vehicle dispatch request has been received, and the riding position and the destination of the user 5 included in the request, on the display of the navigation device of the own vehicle.

The vehicle dispatch request to be transmitted to the on-vehicle device 4 may include the optimum route calculated by the vehicle dispatch server 2. In this case, the on-vehicle device 4 that has received the vehicle dispatch request displays a road map on which the optimum route is superimposed, on the display of the navigation device of the own vehicle.

The display screen displayed on the display by the on-vehicle device 4 includes information that prompts the driver to input whether to accept or reject the vehicle dispatch.

In this case, when the driver performs input of acceptance or rejection of the vehicle dispatch into the input interface of the on-vehicle device 4, the on-vehicle device 4 transmits a vehicle dispatch response including information of acceptance or rejection, to the vehicle dispatch server 2 (step ST20).

When the information included in the vehicle dispatch response is “acceptance”, the vehicle dispatch server 2 that has received the vehicle dispatch response determines the vehicle 3 including the on-vehicle device 4 that is the transmission source of the vehicle dispatch response, as a vehicle 3 to be dispatched to the user 5 (hereinafter, referred to as a “dispatch vehicle” (step ST15).

When the information included in the vehicle dispatch response is “rejection”, the vehicle dispatch server 2 that has received the vehicle dispatch response excludes the vehicle 3 including the on-vehicle device 4 that is the transmission source of the vehicle dispatch response, from the candidate vehicles, and re-executes each process from step ST12 to step ST14.

As described above, the vehicle dispatch server 2 repeats each process from step ST12 to step ST14 until a candidate vehicle (dispatch vehicle) that accepts the vehicle dispatch request is determined.

In the vehicle dispatch confirmation process (step ST14), the vehicle dispatch request may be simultaneously transmitted to a plurality of candidate vehicles whose transmission ranks are the first to predetermined places (for example, the candidate vehicles whose transmission ranks are the first to third places) instead of being transmitted to only the candidate vehicle whose transmission rank is the first place. In this case, the vehicle dispatch server 2 may execute the following process with the plurality of candidate vehicles.

That is, when the vehicle dispatch server 2 receives only one vehicle dispatch response of acceptance, the vehicle dispatch server 2 may determine the vehicle 3 that is the transmission source of the vehicle dispatch response, as a dispatch vehicle, and may transmit vehicle dispatch cancellation to the on-vehicle devices 4 of the other vehicles 3.

When the vehicle dispatch server 2 receives a plurality of vehicle dispatch responses of acceptance, the vehicle dispatch server 2 may determine the vehicle 3 having the highest transmission rank among the vehicles 3 that are the transmission sources of the vehicle dispatch responses, as a dispatch vehicle, and may transmit vehicle dispatch cancellation to the on-vehicle devices 4 of the other vehicles 3.

Next, the vehicle dispatch server 2 executes a “vehicle dispatch response generation/transmission process” to the user terminal 6 (step ST16).

The vehicle dispatch response generation/transmission process is a process of generating a vehicle dispatch response including vehicle information of the determined dispatch vehicle and an estimated time of arrival at the riding position of the user 5, and transmitting the generated vehicle dispatch response to the user terminal 6 that is the transmission source of the vehicle dispatch request.

The vehicle dispatch server 2 calculates an estimated time of arrival of the dispatch vehicle at the riding position of the user 5, for example, from links to be passed from the current position of the dispatch vehicle to the riding position of the user 5 when the dispatch vehicle travels on the optimum route obtained by the route search process (step ST12), and a link travel time, of each of the links, included in the traffic information database 24.

The vehicle information in the vehicle dispatch response includes, for example, the model of the dispatch vehicle, the name of the dispatch vehicle, the name of the driver, image data of the appearance of the dispatch vehicle, etc.

The user terminal 6 that has received the vehicle dispatch response displays the fact that the vehicle dispatch response has been received, and each piece of the above information included in this response, on the display of the user terminal 6. Therefore, the user 5 can distinguish the dispatch vehicle that has arrived at the user 5, from other vehicles.

### Candidate Vehicle Selection Process

FIG. 5 is a flowchart showing an example of the candidate vehicle selection process.

As shown in FIG. 5, first, the information processing unit 11 of the vehicle dispatch server 2 executes a route-searched vehicle narrowing-down process (step ST31).

The narrowing-down process is a process of, when the number of vehicles 3 for which route search has been performed by the route search process (step ST12 in FIG. 4) exceeds a predetermined number N (for example, N=10), narrowing down the candidate vehicles to a number equal to or less than the predetermined number N according to a predetermined standard.

Therefore, when the number of a plurality of vehicles 3 for which route search has been performed is initially the predetermined number N or less, the narrowing-down process in step ST31 is skipped, and all the empty vehicles 3 for which route search has been performed are set as candidate vehicles.

For example, the predetermined standard may be a standard of being a vehicle 3 having an arrival time, from the current position of the vehicle 3 to the riding position of the user 5, which is as short as possible. In this case, the candidate vehicles are top N empty vehicles 3 having shorter arrival times to the riding position of the user 5.

The predetermined standard may be a standard of being a vehicle 3 having a linear distance, from the current position of the vehicle 3 to the riding position of the user 5, which is as short as possible. In this case, the candidate vehicles are top N empty vehicles 3 having shorter linear distances to the riding position of the user 5.

Next, the information processing unit 11 executes a candidate vehicle ranking process for the top N vehicles 3 (step ST32).

The candidate vehicle ranking process is a process of the information processing unit 11 determining ranks in terms of transmission of a vehicle dispatch request to the on-vehicle device 4, according to a predetermined condition that is set in the storage unit 12 in advance.

The predetermined condition for determining ranks in terms of transmission of a vehicle dispatch request is different depending on a policy of the operator of the vehicle dispatch system 1, but, for example, at least one of the following Conditions 1 to 3 is preferably adopted.

Condition 1: The rank of the vehicle 3 is made higher as the arrival time of the vehicle 3 to the riding position of the user 5 is shorter.

Condition 2: The rank of the vehicle 3 is made higher as the fare of the vehicle 3 is cheaper.

Condition 3: The rank of the type of vehicle 3 desired by the user 5 is made high.

For example, when Condition 1 is adopted, the information processing unit 11 gives a higher transmission rank to a candidate vehicle having a shorter arrival time to the riding position of the user 5.

Similarly, when Condition 2 is adopted, the information processing unit 11 gives a higher transmission rank to a candidate vehicle having a cheaper fare per unit distance or a cheaper fare required for traveling on the optimum route.

Moreover, when Condition 3 is adopted, the information processing unit 11 gives a transmission rank higher than that of any other candidate vehicle, to a candidate vehicle that is of the vehicle type desired by the user 5 (for example, a type in which three or more persons can ride).

It should be noted that, when Condition 3 is adopted, the vehicle type desired by the user 5 needs to be included in the vehicle dispatch request to be transmitted by the user terminal 6.

The candidate vehicle ranking process (step ST32) may include a process of further narrowing down the number of candidate vehicles to a number equal to or less than a predetermined number. For example, in the case where the predetermined number is “6”, the information processing unit 11 excludes the vehicles 3 having determined ranks of “7” or lower, from the candidate vehicles.

Next, the information processing unit 11 executes an upgrading process for electric vehicles 3A (step ST33). The upgrading process for electric vehicles 3A is a process of, when the candidate vehicles include an electric vehicle 3A, the information processing unit 11 upgrading the transmission rank of the electric vehicle 3A according to a predetermined criteria.

Therefore, when the candidate vehicles include no electric vehicle 3A, the process in step ST33 is skipped.

In the upgrading process for electric vehicles 3A, first, the information processing unit 11 narrows down the processing targets to the electric vehicles 3A having a remaining battery charge equal to or larger than an amount of power Br required for traveling on the optimum route to the destination (hereinafter, referred to as a required amount of power).

When the travel distance of the optimum route is denoted by Lo (km) and the electric mileage is denoted by EM (km/kWh), the required amount of power Br is calculated by Br=Lo/EM.

The reason for narrowing down to the electric vehicles 3A having a remaining battery charge equal to or larger than the required amount of power Br as described above is that, when the remaining battery charge is less than the required amount of power Br, the electric vehicle 3A has to be changed while the electric vehicle 3A is carrying the user 5 at this time, so that the convenience of the user 5 is deteriorated.

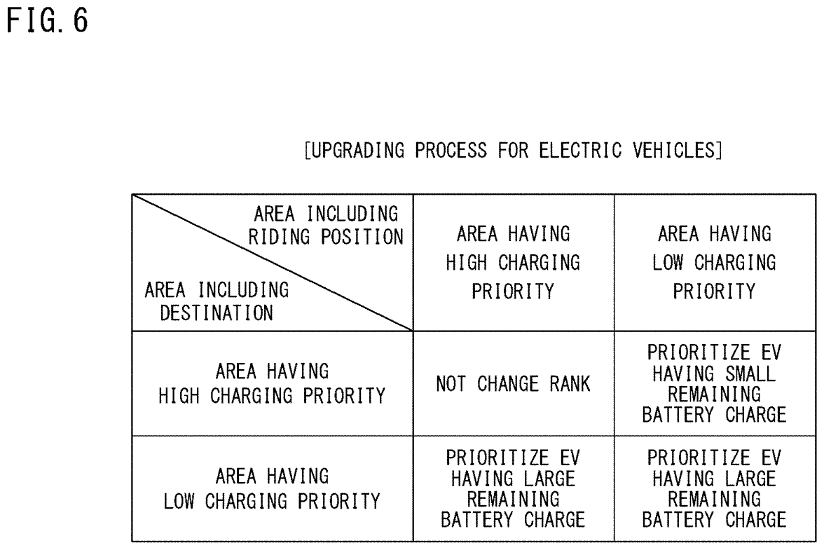

FIG. 6 illustrates a determination table which summarizes the contents of the upgrading process for electric vehicles 3A.

As shown in FIG. 6, for the electric vehicle 3A having a remaining battery charge equal to or larger than the required remaining amount Br, the information processing unit 11 determines which of an EV having a larger remaining battery charge or an EV having a smaller remaining battery charge is prioritized, in accordance with the combination of high/low of the charging priority of the area including the riding position (departure point) and high/low of the charging priority of the area including the destination.

The information processing unit 11 determines each of the charging priorities of the area including the riding position and the area including the destination, on the basis of in which of the areas A1 to A6 of the charging priority map 26 the position information of the riding position or the destination is included.

For example, when the riding position is included in the area A1 in FIG. 3, the information processing unit 11 determines the charging priority of the riding position as “low”, and, when the destination is included in the area A2 in FIG. 3, the information processing unit 11 determines the charging priority of the destination as “high”.

The patterns of determination based on the determination table in FIG. 6 are organized as follows. In the following patterns, “as large as possible” means to be within a predetermined upper range including the maximum, and “as small as possible” means to be within a predetermined lower range including the minimum.

Determination pattern 1: Case where the charging priority of the riding position is “high”/the charging priority of the destination is “high”.

In this case, the information processing unit 11 does not upgrade the transmission rank of any electric vehicle 3A included in the candidate vehicles. That is, the information processing unit 11 maintains the current transmission rank of any electric vehicle 3A.

Determination pattern 2: Case where the charging priority of the riding position is “high”/the charging priority of the destination is “low”.

In this case, the information processing unit 11 prioritizes dispatching the electric vehicle 3A having as large a remaining battery charge as possible. For example, the information processing unit 11 upgrades the transmission rank of the electric vehicle 3A having the maximum remaining battery charge, to the first place. Since it is sufficient that the electric vehicle 3A to be dispatched is the electric vehicle 3A having as large a remaining battery charge as possible, the electric vehicle 3A to be dispatched may be the electric vehicle 3A having the second largest remaining battery charge.

Determination pattern 3: Case where the charging priority of the riding position is “low”/the charging priority of the destination is “high”.

In this case, the information processing unit 11 prioritizes dispatching the electric vehicle 3A having as small a remaining battery charge as possible. For example, the information processing unit 11 upgrades the transmission rank of the electric vehicle 3A having the minimum remaining battery charge, to the first place. Since it is sufficient that the electric vehicle 3A to be dispatched is the electric vehicle 3A having as small a remaining battery charge as possible, the electric vehicle 3A to be dispatched may be the electric vehicle 3A having the second smallest remaining battery charge.

Determination pattern 4: Case where the charging priority of the riding position is “low”/the charging priority of the destination is “low”.

In this case, the information processing unit 11 prioritizes dispatching the electric vehicle 3A having as large a remaining battery charge as possible. For example, the information processing unit 11 upgrades the transmission rank of the electric vehicle 3A having the maximum remaining battery charge, to the first place. Since it is sufficient that the electric vehicle 3A to be dispatched is the electric vehicle 3A having as large a remaining battery charge as possible, the electric vehicle 3A to be dispatched may be the electric vehicle 3A having the second largest remaining battery charge.

The process contents based on the determination patterns 1 to 4 described above are summarized as follows.

When the charging priority of the area including the riding position is low and the charging priority of the area including the destination is high, the information processing unit 11 prioritizes dispatching the electric vehicle 3A having a remaining battery charge that is equal to or larger than the required remaining amount Br and is as small as possible (for example, the minimum) (determination pattern 3).

Therefore, a possibility that the driver of the electric vehicle 3A will charge the electric vehicle 3A in the area including the destination and having a high charging priority, rather than in the area including the riding position and having a low charging priority, is increased.

For example, in the case where the charging priority is defined by the “power supply and demand situation”, a possibility that charging will be performed in the area including the destination and having a margin in the power supply and demand situation, rather than in the area including the riding position and having no margin in the power supply and demand situation, is increased.

In the case where the charging priority is defined by the “charging station installation density”, a possibility that charging will be performed in the area including the destination and having a high installation density, rather than in the area including the riding position and having a low installation density, is increased.

Similarly, in the case where the charging priority is defined by the “renewable energy utilization rate”, a possibility that charging will be performed in the area including the destination and having a high utilization rate, rather than in the area including the riding position and having a low utilization rate, is increased.

Meanwhile, when the charging priority of the area including the destination is low, the information processing unit 11 prioritizes dispatching the electric vehicle 3A having a remaining battery charge that is equal to or larger than the required remaining amount Br and is as large as possible (for example, the maximum) (determination patterns 2 and 4).

Therefore, a possibility that the driver of the electric vehicle 3A will charge the electric vehicle 3A in the area including the destination and having a low charging priority, is decreased.

For example, in the case where the charging priority is defined by the “power supply and demand situation”, a possibility that charging will be performed in the area including the destination and having no margin in the power supply and demand situation, is decreased.

In the case where the charging priority is defined by the “charging station installation density”, a possibility that charging will be performed in the area including the destination and having a low installation density, is decreased.

In the case where the charging priority is defined by the “renewable energy utilization rate”, a possibility that charging will be performed in the area including the destination and having a low utilization rate, is decreased.

As described above, in the case where the charging priority is defined by the “power supply and demand situation”, a possibility that charging will be performed in the area including the destination and having a margin in the power supply and demand situation can be increased, or a possibility that charging will be performed in the area including the destination and having no margin in the power supply and demand situation can be decreased.

Therefore, a value of adjusting power demand between areas can be added to a vehicle dispatch service performed for taxies, ride sharing, etc.

Moreover, if the penetration rate of the electric vehicles 3A increases, it is considered that the fee for charging the electric vehicle 3A will also vary depending on the power supply and demand situation.

Therefore, when a vehicle dispatch service that promotes charging in an area having a margin in the power supply and demand situation can be performed as in the present embodiment, there is a possibility that the fee for charging the electric vehicle 3A included in the vehicle dispatch system 1 will become cheaper, and the fare of the user 5 is also expected to become cheaper.

### First Modification

In the above-described embodiment, the on-vehicle device 4 of each vehicle 3 may execute the route search process (step ST12 in FIG. 4), and the vehicle dispatch server 2 may collect the search results. The sequence of information processing in this case is, for example, as follows.

1) Upon receiving a vehicle dispatch request from the user terminal 6, the vehicle dispatch server 2 transmits a search request including a riding position and a destination of the user 5, to the on-vehicle device 4 of each empty vehicle 3 located within a predetermined range.

2) Each on-vehicle device 4 that has received the search request searches for an optimum route to be taken in the case of traveling from the current position of the own vehicle via the riding position to the destination.

3) The on-vehicle device 4 of each vehicle 3 transmits a search response including route information (link numbers, node numbers, etc.) of the optimum route that is the search result, to the vehicle dispatch server 2.

4) The vehicle dispatch server 2 executes the “candidate vehicle selection process” (step ST13 in FIG. 4 and FIG. 5) by using the route information of the optimum route received from each vehicle 3.

5) The vehicle dispatch server 2 executes the “vehicle dispatch confirmation process” (step ST14 in FIG. 4) for the selected candidate vehicles.

6) When a dispatch vehicle is determined through the vehicle dispatch confirmation process, the vehicle dispatch server 2 executes the “vehicle dispatch response generation/transmission process” (step ST16 in FIG. 4).

### Second Modification

In the above-described embodiment, a riding position and a destination may be registered for identification information of each user 5 in the member database 23 of the vehicle dispatch server 2 in advance, and, when a vehicle dispatch request is received from the user terminal 6, the riding position (for example, home) and the destination (for example, a hospital, restaurant, or the like regularly visited by the user) corresponding to the identification information of the user 5 may be acquired from the member database 23.

In this case, the riding position and the destination of the user 5 do not need to be included in the vehicle dispatch request to be transmitted by the user terminal 6, and the member database 23, in which the riding position and the destination of each user 5 are registered in advance, is an acquisition source of such information.

On the other hand, in the above-described embodiment, the communication unit 13, which receives a vehicle dispatch request including the riding position and the destination of the user 5, is an acquisition source of such information.

Therefore, the user terminal 6 is not necessarily limited to a data communication terminal that can be carried by the user 5, and may be, for example, a fixed terminal capable of performing wired communication with the vehicle dispatch server 2, such as a taxi call telephone installed at a shopping center or a desktop PC at home.

As described above, in addition to the mobile terminal possessed by the user 5, the user terminal 6 may be a fixed terminal capable of transmitting and receiving a vehicle dispatch request and a vehicle dispatch response by wired communication.

### Third Modification

In the above-described embodiment, instead of the charging priority of the area including the “riding position of the user”, the charging priority of the area including the “current position of the electric vehicle 3A” may be adopted.

In this case, the “area including the riding position” in FIG. 6 may be replaced with the “area including the current position”, and the information processing unit 11 may execute the upgrading process for electric vehicles 3A.

### Other Modifications

The above-described embodiment (including the modifications) is illustrative in all aspects and not restrictive. All changes which come within the range of equivalency of the configurations recited in the claims are intended to be included in the scope of the present invention.

For example, in the above-described embodiment, the vehicle dispatch system 1 in which the on-vehicle devices 4 of the electric vehicles 3A and the on-vehicle devices 4 of the normal vehicles 3B coexist has been illustrated, but the vehicle dispatch system 1 may be a system merely including the on-vehicle devices 4 of the electric vehicles 3A.

In the above-described embodiment, it is assumed that the driver of each vehicle 3 is a human, but the vehicle 3 may be an automated driving vehicle having a level of 4 or higher at which a human is not involved in driving.

In the above-described embodiment, the user 5 who is a beneficiary of the vehicle dispatch service may be a person different from the user of the user terminal 6 (for example, a parent or friend of the user of the user terminal 6). In this case, the user of the user terminal 6 may transmit a vehicle dispatch request instead of the user 5 that is the beneficiary.

### APPLICATION EXAMPLE 1

### Case of Dispatching a Package Transporting Vehicle

The above-described embodiment (including the modifications) can be applied not only to dispatching a passenger car in which the user 5 themselves rides, but also to dispatching a vehicle for transporting a package of the user 5.

For example, the case of dispatching a transporting vehicle that carries a package of the user 5 from a predetermined “pick-up position” to a “delivery destination” is assumed. The pick-up position is, for example, the current position of the user 5, the position of a collection box, or the like, and the “delivery destination” is the delivery destination of the package, the position of a delivery center, or the like.

In this case, in the above-described embodiment, the “riding position of the user 5” may be replaced with the “pick-up position of the package” of the user 5, and the “destination of the user 5” may be replaced with the “delivery destination of the package”.

Therefore, when the above-described embodiment is applied to dispatching a package transporting vehicle, claim 1 is, for example, as follows.

### Claim 1 in the Case of Application Example 1

A computer program for causing a computer to function as a device for dispatching a vehicle to a user, the computer program causing the computer to function as:

an acquisition unit configured to acquire a vehicle dispatch request; and

an information processing unit configured to select candidate vehicles that are candidates to be dispatched to the user, in accordance with the acquired vehicle dispatch request, wherein

when the selected candidate vehicles include an electric vehicle, the information processing unit determines the electric vehicle to be dispatched, on the basis of a charging priority of an area including a pick-up position of the package or a current position of the electric vehicle, a charging priority of an area including a delivery destination of the package, and a remaining battery charge of the electric vehicle.

### APPLICATION EXAMPLE 2

### Case of Dispatching a Service Vehicle

The above-described embodiment (including the modifications) can be applied not only to dispatching a passenger car in which the user 5 themselves ride, but also to dispatching a vehicle that provides a predetermined service (hereinafter, referred to as a “service vehicle”), to a predetermined service providing point.

Examples of the service vehicle include public emergency vehicles such as police cars or ambulances, private emergency vehicles owned by security companies, maintenance vehicles for maintenance and inspection of roads, gas, electricity, communication lines, etc., and vehicles for door-to-door sales.

In this case, in the above-described embodiment, the “riding position of the user 5” is unnecessary, and the “destination of the user 5” may be replaced with the “service providing point”.

Therefore, when the above-described embodiment is applied to dispatching a service vehicle, claim 1 is, for example, as follows.

### Claim 1 in the Case of Application Example 2

A computer program for causing a computer to function as a device for dispatching a vehicle to a user, the computer program causing the computer to function as:

an acquisition unit configured to acquire a vehicle dispatch request; and

an information processing unit configured to select candidate vehicles that are candidates to be dispatched to the user, in accordance with the acquired vehicle dispatch request, wherein

when the selected candidate vehicles include an electric vehicle, the information processing unit determines the electric vehicle to be dispatched, on the basis of a charging priority of an area including a current position of the electric vehicle, a charging priority of an area including the service providing point, and a remaining battery charge of the electric vehicle.

### REFERENCE SIGNS LIST

1 vehicle dispatch system
2 vehicle dispatch server (vehicle dispatch device)
3 vehicle
3A electric vehicle (EV)
3B normal vehicle
4 on-vehicle device
5 user
6 user terminal
7 wireless base station
8 public communication network
10 server computer
11 information processing unit (acquisition unit)
12 storage unit
13 communication unit (acquisition source)
14 computer program
15 traffic information server
21 map database
22 vehicle database
23 member database (acquisition source)
24 traffic information database
25 road map data
26 charging priority map
41 processing unit
42 storage unit
43 communication unit
44 computer program

1. A non-transitory computer-readable storage medium having stored therein a computer program for causing a computer to function as a device for dispatching a vehicle to a user, the computer program causing the computer to function as:
an acquisition unit configured to acquire a vehicle dispatch request; and
an information processing unit configured to select candidate vehicles that are candidates to be dispatched to the user, in accordance with the acquired vehicle dispatch request, wherein
when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

2. The storage medium according to claim 1, wherein, when the charging priority of the area including the riding position of the user or the current position of the electric vehicle is low and the charging priority of the area including the destination of the user is high, the information processing unit prioritizes dispatching the electric vehicle having a remaining battery charge that is equal to or larger than an amount of power required for travelling to the destination and is as small as possible.

3. The storage medium according to claim 1, wherein, when the charging priority of the area including the destination of the user is low, the information processing unit prioritizes dispatching the electric vehicle having a remaining battery charge that is equal to or larger than an amount of power required for travelling to the destination and is as large as possible.

4. The storage medium according to claim 1, wherein the information processing unit determines the charging priority of each of the areas on the basis of a power supply and demand situation of the area.

5. The storage medium according to claim 1, wherein the information processing unit determines the charging priority of each of the areas on the basis of a charging station installation density of the area.

6. The storage medium according to claim 1, wherein the information processing unit determines the charging priority of each of the areas on the basis of a renewable energy utilization rate of the area.

7. The storage medium according to claim 1, wherein, when the vehicle dispatch request includes the riding position and the destination of the user, the acquisition unit acquires the vehicle dispatch request including the riding position and the destination of the user.

8. A method for dispatching a vehicle to a user, the method comprising:
a first step of acquiring a vehicle dispatch request; and
a second step of selecting candidate vehicles that are candidates to be dispatched to the user, in accordance with the acquired vehicle dispatch request, wherein
the second step includes a step of, when the selected candidate vehicles include an electric vehicle, determining the electric vehicle to be dispatched, on the basis of a charging priority of an area including a riding position of the user or a current position of the electric vehicle, a charging priority of an area including a destination of the user, and a remaining battery charge of the electric vehicle.

9. A device for dispatching a vehicle to a user, the device comprising:
an acquisition unit configured to acquire a vehicle dispatch request; and
an information processing unit configured to select candidate vehicles that are candidates to be dispatched to the user, in accordance with the acquired vehicle dispatch request, wherein
when the selected candidate vehicles include an electric vehicle, the information processing unit determines the electric vehicle to be dispatched, on the basis of a charging priority of an area including a riding position of the user or a current position of the electric vehicle, a charging priority of an area including a destination of the user, and a remaining battery charge of the electric vehicle.

10. (canceled)
